(19) United States
(12) Patent Application Publication
(10) Pub. No.: US 2016/0258440 A1
(43) Pub. Date: Sep. 8, 2016

(54) GAS TURBINE ENGINE WITH AIRFOIL DAMPENING SYSTEM

(71) Applicant: Rolls-Royce Corporation, Indianapolis, IN (US)

(72) Inventor: Mark S. Henry, Indianapolis, IN (US)

(21) Appl. No.: 15/056,317

(22) Filed: Feb. 29, 2016

Related U.S. Application Data
(60) Provisional application No. 62/126,943, filed on Mar. 2, 2015.

(51) Int. Cl. F04D 27/00; F04D 29/66; F04D 29/38; F04D 29/56; F04D 29/52; F04D 29/32

(52) U.S. Cl. CPC F04D 27/009; F04D 29/522; F04D 29/321; F04D 29/325; F04D 29/38; F04D 27/001; F04D 29/563; F04D 29/668; F05D 2220/32; F05D 2260/96; F05D 2270/334; F05D 2270/62; F05D 2270/80; F05D 2240/128

(57) ABSTRACT

A gas turbine engine includes a central wheel and a plurality of blades that extend outwardly from the central wheel. The gas turbine system includes a flutter control system that is adapted to use blade tip timing to determine blade flutter and to direct high pressure air from the compressor to the fan blade row to alter the surface unsteady pressure so that it is out of phase with the blade motion to reduce or eliminate fan blade flutter.

### CROSS REFERENCE TO RELATED APPLICATIONS

This application claims priority to and the benefit of U.S. Provisional Patent Application Number 62/126,943, filed 2 Mar. 2015, the disclosure of which is now expressly incorporated herein by reference.

### FIELD OF THE DISCLOSURE

The present disclosure relates generally to gas turbine engines, and more specifically to bladed rotors used in gas turbine engines.

### BACKGROUND

Gas turbine engines are used to power aircraft, watercraft, power generators, pumps, and the like. Gas turbine engines operate by compressing atmospheric air, burning fuel with the compressed air, and then removing work from hot high-pressure air produced by combustion of the fuel in the air. Rows of rotating blades and non-rotating vanes are used to compress the air and then to remove work from the high-pressure air produced by combustion. Each blade and vane has an airfoil that interacts with the gasses as they pass through the engine.

Airfoils have natural vibration modes of increasing frequency and complexity of the mode shape. The simplest and lowest frequency modes are typically referred to as the first bending mode, the second bending mode, the third bending mode, and the first torsion mode. The first bending mode is a motion normal to the working surface of an airfoil in which the entire span of the airfoil moves in the same direction. The second bending mode is similar to the first bending mode, but with a change in the sense of the motion somewhere along the span of the airfoil, so that the upper and lower portions of the airfoil move in opposite directions. The third bending mode is similar to the second bending mode, but with two changes in the sense of the motion somewhere along the span of the airfoil. The first torsion mode is a twisting motion around an elastic axis, which is parallel to the span of the airfoil, in which the entire span of the airfoil, on each side of the elastic axis, moves in the same direction.

Blades are subject to destructive vibrations induced by unsteady interaction of the airfoils of those blades with gasses passing through a gas turbine engine. One type of vibration is known as flutter, which is an aero-elastic instability resulting from the interaction of the flow over the airfoils of the blades and the blades' natural vibration tendencies. The lowest frequency vibration modes, the first bending mode and the first torsion mode, are often the vibration modes that are susceptible to flutter.

When flutter occurs, the unsteady aerodynamic forces on the blade, due to its vibration, add energy to the vibration, causing the vibration amplitude to increase. The vibration amplitude can become large enough to cause damage to a blade. Another type of vibration is known as forced response, which is an aero-elastic response to inlet distortion or wakes from upstream airfoils, struts, or any other flow obstruction. The operable range, in terms of pressure rise and flow rate, of turbomachinery can sometimes be restricted by flutter or forced response phenomena.

Flutter instability can degrade the performance of the rotary compressor and may also lead to fatigue failure or other permanent damage to the compressor. One result of the flutter instability can be blade deformation and/or blade fatigue failure. Thus, it is desirable to avoid rotary compressor blade motion that causes flutter.

### SUMMARY

The present disclosure may comprise one or more of the following features and combinations thereof.

A rotor for use in a gas turbine engine may include a central wheel, and a plurality of blades having blade tips. The central wheel may be arranged around a central axis. The plurality of fan blades extend outward from the central wheel in a radial direction away from the central axis.

In illustrative embodiments, a flutter control system for a turbomachine fan includes a plurality of optical tip timing sensors located in a fan case of the turbomachine and configured to sense the passing of blade tips of a fan of the turbomachine. A controller is operably connected to the plurality of optical tip timing sensors. A series of nozzles are located in the fan case and directed at the edges of the blades. High pressure air off of the compressor is directly injected into the blade row to alter unsteady pressure. A nozzle actuator is operably connected to the controller, such that the nozzle actuator selectively actuates the nozzles directed at the edges of the blades in response to data from the plurality of optical tip timing sensors indicating flutter or near flutter conditions. Data from the plurality of optical tip timing sensors is compared to a threshold value and the nozzles are actuated based on the comparison to dampen flutter of the plurality of fan blades.

In illustrative embodiments, optical tip timing sensors sense vibrations produced by a rotating blade and generate flutter signals that are a function of the sensed vibration. The flutter signals are transmitted to the processor in the controller. The processor generates a control signal based on the flutter signals and transmits the control signal to a nozzle actuator for controlling the position of the actuator, thereby modulating the discharge of high pressure compressor gases from the nozzles.

In illustrative embodiments, a third aspect of the disclosure is drawn to a method for reducing flutter instability wherein the steps of the method are stored on a computer-readable medium and comprise a method for reducing instability of a fan blade stored on a computer-readable medium comprising, generating a substantially parabolic flutter boundary curve representing flutter parameters of the fan blade, sensing flutter vibrations of the compressor, calculating a differential quantity representative of the difference between the flutter boundary curve and the operating mode, comparing the flutter vibrations to the differential quantity, operating the actuator to permit the flow of high pressure compressor gasses through the nozzles when the magnitude of the flutter vibration is greater than the differential quantity and monitoring the relationship of the magnitude of the flutter vibration and the differential quantity; and discontinuing the flow of high pressure compressor gasses through the nozzles when the flutter vibration is less than the differential quantity.

These and other features of the present disclosure will become more apparent from the following description of the illustrative embodiments.

### BRIEF DESCRIPTION OF THE DRAWINGS

FIG. 1 illustrates a general partial cut-away view of a gas turbine engine having optical tip timing sensors positioned at the fan blade tip;

FIG. 2 is a schematic view of an example gas turbine engine having a flutter control system; and

FIG. 3 is a side elevation view of a fan blade included in the fan rotor.

### DETAILED DESCRIPTION OF THE DRAWINGS

For the purposes of promoting an understanding of the principles of the disclosure, reference will now be made to a number of illustrative embodiments illustrated in the drawings and specific language will be used to describe the same.

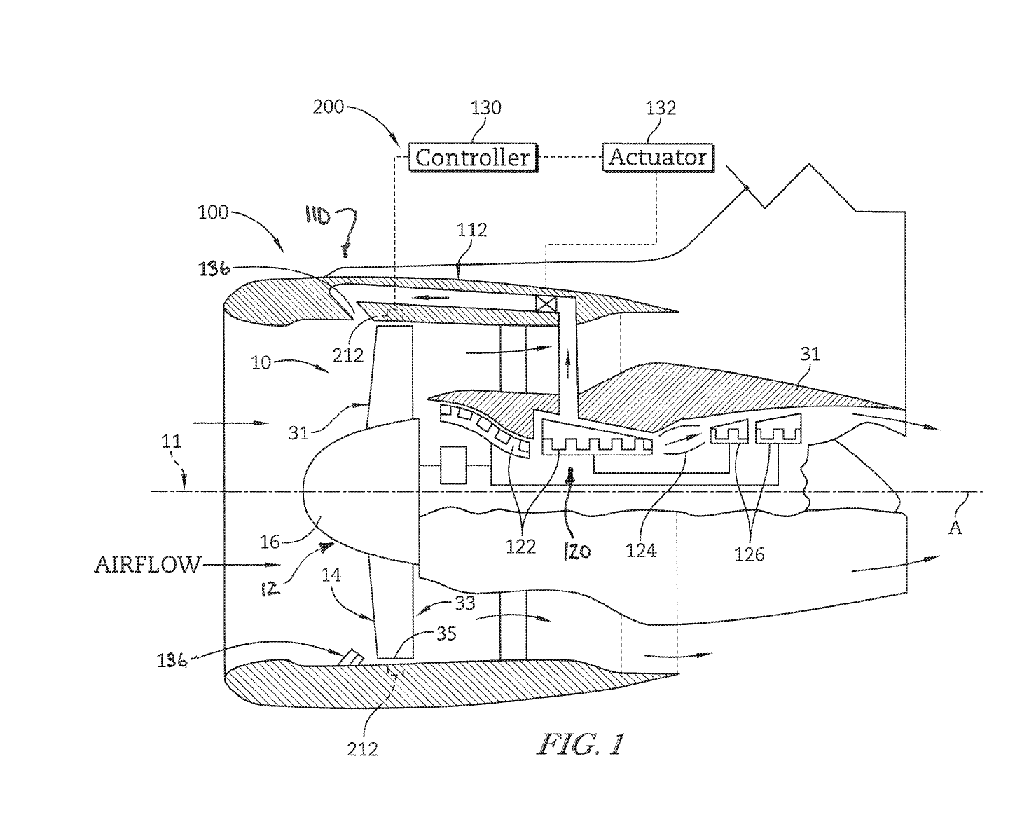

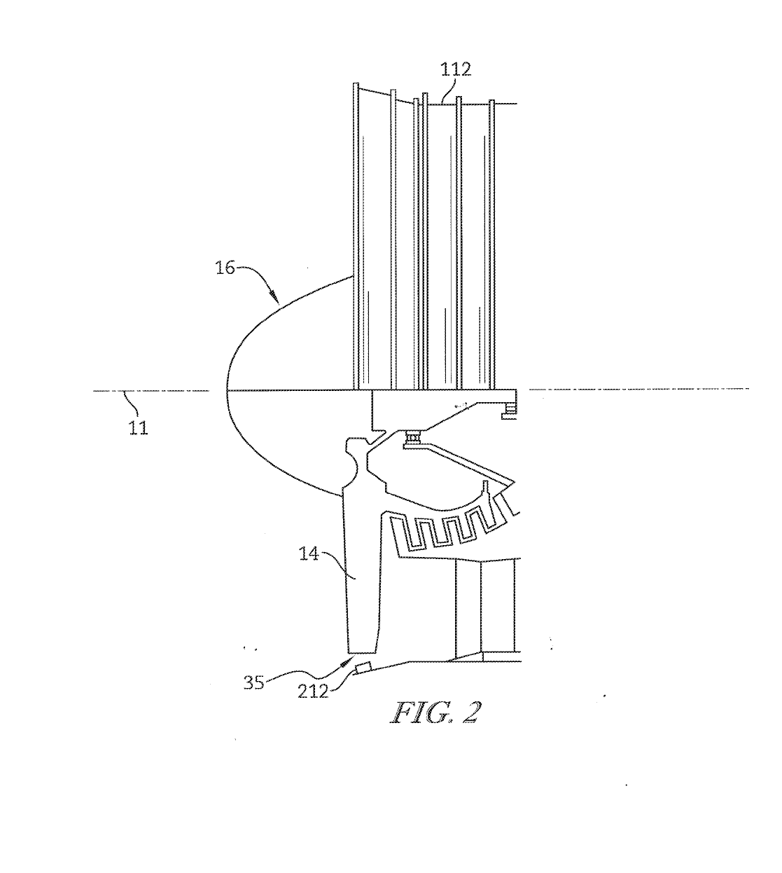

An illustrative aerospace gas turbine engine 100 includes a fan assembly 110 adapted to accelerate/blow air so that the air provides thrust for moving an aircraft as shown in FIGS. 1 and 2. The illustrative fan assembly 110 includes a fan rotor 10 that rotates about a central axis 11 and a fan case 112 mounted to extend around the fan rotor 10. A flutter control system 200 is illustratively designed to reduce flutter effects induced into the fan rotor 10 during operation of the gas turbine engine 100.

The fan rotor 10 includes a central fan wheel 12, a plurality of fan blades 14, and a spinner 16 as shown, for example, in FIG. 1. The central fan wheel 12 is arranged around the axis 11. The plurality of fan blades 14 extend outwardly from the central fan wheel 12 in the radial direction away from the axis 11. The spinner 16 is coupled to the central fan wheel 12 and directs air radially-outward from the axis 11 toward the plurality of fan blades 14 so that the fan blades 14 can accelerate/blow the air.

The fan rotor 10 is illustratively mounted to a turbine engine core 120 to be rotated by the engine core 120 as suggested, for example, in FIG. 1. The engine core 120 includes a compressor 122, a combustor 124, and a turbine 126 all mounted to a case. The compressor 122 is configured to compress and deliver air to the combustor 124. The combustor 124 is configured to mix fuel with the compressed air received from the compressor 122 and to ignite the fuel. The hot high pressure products of the combustion reaction in the combustor 124 are directed into the turbine 126 and the turbine 126 extracts work to drive the compressor 122 and the fan rotor 10.

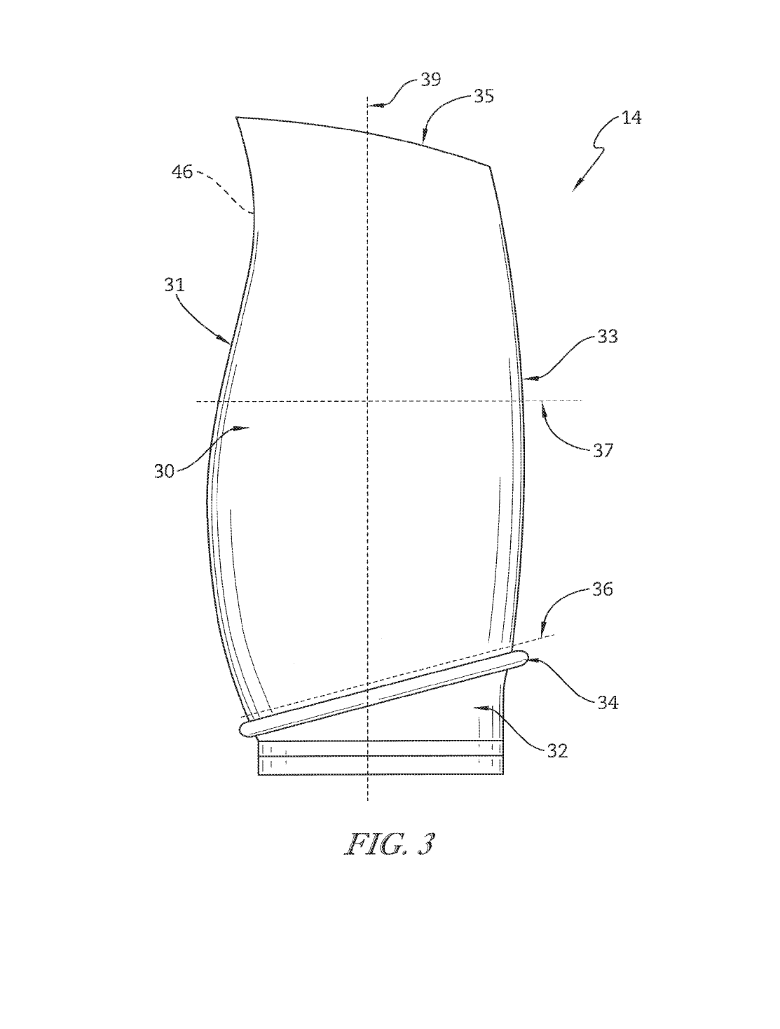

Fan blade 14 illustratively includes an airfoil 30, a root 32, and a platform 34, as shown in FIG. 3. The airfoil 30 has an aerodynamic shape for accelerating/blowing air. The root 32 is shaped to be received in a corresponding receiver formed in the central fan wheel 12 to couple fan blade 14 to the fan wheel 12. The platform 34 connects the root 32 to the airfoil 30 and separates the root 32 from the airfoil 30 so that gasses passing over the airfoil 30 are blocked from moving down around the root 32. In other embodiments, the airfoil 30 may be integrally coupled to the central wheel 12 during manufacturing such that the fan rotor 10 is a bladed disk.

The fan blade 14 has a notional first bend mode node line 36 that extends axially the airfoil 30 from a leading edge 31 to a trailing edge 33 of the airfoil 30 adjacent to the platform 34 as shown in FIG. 3. The fan blade 14 also has a notional second bend mode node line 37 that extends axially across the airfoil 30 from the leading edge 31 to the trailing edge 33 of the airfoil 30 and that is spaced apart from the platform 34.

Fan blade 14 also has notional third bend mode node lines (not shown) that extend axially across the airfoil 30 from the leading edge 31 to the trailing edge 33 of the airfoil 30 and that are spaced apart from the platform 34. Fan blade 14 further has a notional first torsion node line 39 that extends radially along the airfoil 30. Generally, the first, second, and third bend modes along with the first torsion mode make up low order modes that affect fan blade 14.

FIGS. 1 and 2 illustrate an embodiment of an active flutter control system 200. An optical sensor based system is described for real time monitoring of flutter in rotating turbomachinery. The digital flutter monitoring system is designed for continuous processing of blade tip timing data. Data from all blades 14 can be collected to determine the vibration amplitude of each blade 14. Blade tip responses from optical tip timing sensors 212 can be determined by using this system.

Fan blades 14 have a high aspect ratio (e.g. tall relative to chord and thickness) and are prone to easily vibrate under certain conditions. Not all fan blades 14 flutter but if a fan blade does flutter, it can cause high vibratory stresses and may result in fatigue failure. There is variability in manufacturing which affects the mode shape and frequency but the bigger unknown is the aerodynamic damping. When designing a fan blade, the aerodynamic damping is either estimated or based on test data from previous designs which may be similar. Blade tip timing (BTT) gives near real time information on fan blade 14 response. An asynchronous response may indicate flutter activity and by altering the phase of the surface unsteady pressure with respect to the airfoil motion, flutter may be inhibited. To control flutter, the twisting and bending motions must be measured along a section of the wing containing the leading and trailing edge control surfaces.

The flutter control system 200 includes a plurality of optical tip timing sensors 212 located in a fan case 112 of a gas turbine engine 100. Optical tip timing sensors 212 are located to observe arrival timing of a plurality of fan blades 14 fixed to a fan rotor 10 as the plurality of fan blades 14 rotate about central axis 11. In one example, optical tip timing sensors 212 are located in the fan case 112 to monitor passing of a leading edge 31, trailing edge 33, and mid-chord 35 of the plurality of fan blades 14. The optical tip timing sensors 212 monitor the leading edge 31 and trailing edge 33 utilized to determine fan blade 14 twist.

Optical tip timing sensors 212 are installed at the leading edge and sometimes at the trailing edge. For blade flutter, a minimum of three optical tip timing sensors 212 would be installed in each plane. If two planes are used, installation may be accomplished on leading edge or trailing edge alone. Optical tip timing sensors 212 would be in close proximity in angular positioning and would not be equally spaced around the circumference of the fan. For example, the optical tip timing sensors 212 may be arranged within 180 degrees or less of the fan circumference, within 90 degrees or less of the fan circumference, within 45 degrees or less of the fan circumference, within 30 degrees or less of the fan circumference, within 15 degrees or less of the fan circumference, or within 10 degrees or less of the fan circumference. This allows for collection of more tip passing data and correlation and/or verification of data.

Together, the information from the optical tip timing sensors 212 is communicated to a digital controller 130. The digital controller 130 compares the passing timing of the fan blades 14 to a threshold, to determine if a fan blade 14 is approaching a flutter condition or is actively fluttering. The digital controller 130 is sensing asynchronous vibration on the fan blade 14. Based on the comparison, the digital controller 130 sends commands to a fan nozzle actuator 132. The fan nozzle actuators 132 direct high pressure air from the compressor to exit through one or more fan nozzles 136 into the fan blade row in order to alter the surface unsteady pressure so that it is out of phase with the blade motion, increase the aerodynamic damping, increase the stall margin and make it more difficult for the fan blades 14 to flutter or if caught early enough, impede flutter potential. Use of compressor gases through fan nozzles 136 ensures that sufficient back pressure is applied to the fan blades 14 to dampen out flutter as measured by the optical tip timing sensors 212.

Fan blades 14 are continually monitored by optical tip timing sensors 212 during the application of high pressure compressor gasses through fan nozzles 136. As fan blade flutter subsides, controller 130 closes actuator 132 to discontinue the flow of compressor gasses to fan nozzles 136. The duration of the application of compressor gasses through fan nozzles 136 is dependent upon the amount of time it takes to dampen fan blade flutter.

FIG. 1 illustrates the flutter control system 200 of the gas turbine engine 100. The discharge through fan nozzles 136 may be changed during certain flight conditions, such as flutter conditions, by opening or closing the fan nozzle actuators 132. Flutter conditions represent self-induced oscillations. Flutter conditions are caused by unsteady aerodynamic conditions such as the interaction between adjacent airfoils. During flutter, aerodynamic forces couple with each airfoil's elastic and inertial forces, which may increase the kinetic energy of each airfoil and produce negative damping. The negative damping is enhanced where adjacent airfoils begin to vibrate together.

The fan nozzle actuator 132 is selectively controlled by the digital controller 130 to control the air pressure through fan nozzle 136. The flutter control system 200 is a closed-loop system and includes one or more optical tip timing sensors 212 and a digital controller 130. The optical tip timing sensors 212 actively and selectively detect the flutter condition of one or more fan blades 14 and communicates with the digital controller 130 to actuate the fan nozzle actuators 132. The illustration provided is highly schematic. In one example, the optical tip timing sensors 212 are a time of arrival type sensor. The optical tip timing sensors 212 time the passage (or arrival time) of one or more fan blades 14 as the fan blades 14 pass a fixed, case-mounted sensor as the air fan blades 14 rotate about the engine longitudinal centerline axis A. The arrival time of the fan blades 14 are timed by the optical tip timing sensors 212. Other fan blades 14 may similarly be timed. The digital controller 130 is programmed to differentiate between which fan blade 14 arrival times correlate to a flutter condition and which fan blade 14 arrival times correlate to non-flutter conditions. According to the present disclosure, rotors for various parts of a gas turbine engine such as compressors and turbines may be provided that are less susceptible to damage as a result of flutter or forced response effects.

According to one method of controlling flutter in a fan included in a gas turbine engine, a system of the present disclosure may perform the steps of: measuring blade tip timing of fan blades included in the fan as they rotate about an axis, determining when a flutter condition or pre-flutter condition exists, and directing high pressure air from a compressor included in the gas turbine engine toward the fan blades to create a disturbance out of phase with unsteady pressures acting upon the fan blades.

The step of measuring blade tip timing of fan blades included in the fan as they rotate about an axis may be performed by optical tip timing sensors positioned along at least one of the leading edge and trailing edge of the fan blades. The optical tip timing sensors may monitor the leading edge and trailing edge of the fan blades and transmit acquired data to the digital controller.

The step of determining when a flutter condition or pre-flutter condition exists may be performed by comparing the blade data measured by optical tip timing sensors to known values to determine whether a flutter condition or a pre-flutter condition is present.

The step of directing high pressure air from a compressor included in the gas turbine engine toward the fan blades to create a disturbance out of phase with unsteady pressures acting upon the fan blades may be performed by a digital controller that operating an actuator to direct high pressure air through one or more nozzles directed at the fan blades.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. A fan assembly for a gas turbine engine, comprising:
a compressor for compressing air entering the gas turbine engine;
a fan case for encasing the compressor;
a central fan wheel positioned within the fan case and having a central axis,
a plurality of fan blades that extend outward from the central fan wheel in a radial direction away from the central axis, each of the fan blades formed to include a leading edge, a trailing edge and a mid chord positioned between the leading and trailing edges;
a flutter control system comprising at least one optical tip timing sensor positioned within the fan case and a digital controller electrically coupled to the at least one optical tip timing sensor, wherein the flutter control system is adapted to measure blade tip timing of the fan blades and determine when a flutter condition exists, the flutter control system is adapted to direct high pressure air from the compressor toward the fan blades to create a disturbance out of phase with unsteady pressures acting upon the fan blades.

2. The fan assembly of claim 1, wherein the flutter control system includes at least one fan nozzle positioned within the compressor housing, the at least one fan nozzle is adapted to direct high pressure air toward the fan blade to create the disturbance out of phase with unsteady pressures acted upon the fan blades.

3. The fan assembly of claim 2, further including an actuator electronically coupled to the digital controller, wherein the actuator is adapted to control the flow of high pressure air from the compressor to the fan nozzle.

4. The fan assembly of claim 1, further including a series of optical tip timing sensors positioned along at least one of the leading edge and trailing edge of the fan blades.

5. The fan assembly of claim 4, wherein the optical tip timing sensors monitor the leading edge and trailing edge of the fan blades and transmit acquired data to the digital controller.

6. The fan assembly of claim 4, wherein the digital controller compares the blade data measured by the optical tip timing sensors to known values to determine whether a blade flutter condition is present.

7. The fan assembly of claim 6, wherein the digital controller operates the actuator to direct high pressure air through one or more nozzles directed at the fan blades to control fan blade flutter.

8. The fan assembly of claim 3, wherein the actuator is positioned within a passageway leading from the compressor to one or more fan nozzles.

9. A flutter control system for a gas turbine engine comprising:
at least one optical tip timing sensor adapted to sense at least the leading edge of a fan blade of the gas turbine engine;
a digital controller electrically coupled to a plurality of optical tip timing sensor,
at least one nozzle adapted to direct high pressure air at the fan blades;
a nozzle actuator in fluid communication with the nozzle and a compressor of the gas turbine engine, the nozzle actuator adapted to selectively allow for the passage of high pressure air from the compressor to the nozzle as directed by the digital controller, wherein the digital controller determines if a flutter or potential flutter condition exists based upon the acquired data from the optical tip timing sensor and causes the nozzle actuator to open to permit high pressure air to flow from the nozzle to dampen the flutter or potential flutter of the fan blade.

10. The flutter control system of claim 9, wherein the optical tip timing sensor monitors the leading edge and trailing edge of the fan blades of the gas turbine engine.

11. The flutter control system of claim 9, wherein the digital controller compares the blade data measured by the optical tip timing sensors to known values to determine whether blade flutter is present in the fan blades.

12. The flutter control system of claim 11, wherein the system includes at least three optical tip timing sensors.

13. The flutter control system of claim 12, wherein the optical tip timing sensors are positioned at the leading edge or trailing edge of the fan blades.

14. The flutter control system of claim 12, wherein the optical tip timing sensors are not equally spaced around the circumference of the fan.

15. A method of controlling flutter in a fan included in a gas turbine engine, the method comprising
measuring blade tip timing of fan blades included in the fan as they rotate about an axis,
determining when a flutter condition or pre-flutter condition exists, and
directing high pressure air from a compressor included in the gas turbine engine toward the fan blades to create a disturbance out of phase with unsteady pressures acting upon the fan blades.

16. The method of claim 15, wherein the step of measuring blade tip timing of fan blades included in the fan as they rotate about an axis is performed by optical tip timing sensors positioned along at least one of the leading edge and trailing edge of the fan blades.

17. The method of claim 16, wherein the optical tip timing sensors monitor the leading edge and trailing edge of the fan blades and transmit acquired data to the digital controller.

18. The method of claim 16, wherein determining when a flutter condition or pre-flutter condition exists is performed by comparing the blade data measured by optical tip timing sensors to known values to determine whether a flutter condition or a pre-flutter condition is present.

19. The method of claim 15, wherein directing high pressure air from a compressor included in the gas turbine engine toward the fan blades to create a disturbance out of phase with unsteady pressures acting upon the fan blades is performed by a digital controller that operating an actuator to direct high pressure air through one or more nozzles directed at the fan blades.

20. The method of claim 15, wherein the system includes at least three optical tip timing sensors that are not equally spaced around the circumference of the fan.
